(19) United States
(12) Patent Application Publication
(10) Pub. No.: US 2007/0155408 A1
(43) Pub. Date: Jul. 5, 2007

(54) Method and apparatus for determining distances between wireless communication devices using low frequency signals

(76) Inventors: John Belcea, West Melbourne, FL (US); Pertti O. Alapuranen, Deltona, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/321,414

(22) Filed: Dec. 29, 2005

(51) Int. Cl. H04Q 7/20

(52) U.S. Cl. 455/458; 455/41.2

(57) ABSTRACT

A wireless communication device (e.g., 102) employs a method and apparatus for determining distances between wireless communications devices in a wireless communication network (100). The wireless device receives an incoming message signal (117) from at least one other wireless device (e.g., 101, 103-104) in the network. The message signal(s) includes a time of arrival of a ranging signal (121) previously transmitted by the wireless device. Responsive to receiving the message signal(s), the wireless device receives one or more incoming ranging signal(s) (120) from the other wireless device(s). Each ranging signal is received in a frequency range that is substantially less than the frequency range in which the messaging signal(s) was received. Having received the message signal(s) and the ranging signal(s), the wireless device then determines the distance between itself and the other wireless device(s) based at least on receipt of the ranging signal(s) and, more preferably, further based on the contents of the message signal(s).

### FIELD OF THE INVENTION

The present invention relates generally to wireless communication systems and, more particularly, to automatically determining distances between mobile wireless communication devices using out-of-band, low frequency signals.

### BACKGROUND OF THE INVENTION

Various techniques for locating wireless communication devices have been developed over the past decade. For example, today, many communication devices, such as cellular telephones, two-way radios, personal digital assistants (PDAs), and even laptop computers, utilize global positioning system (GPS) technology to accurately locate the communication device. However, GPS technology has its limits. In particular, GPS technology only provides accurate location estimation if a communication device is in an environment in which the device can receive transmissions from the satellites of the GPS system. For example, GPS works best to locate communication devices that are outdoors. However, all location needs are not limited to the outdoors. For example, in certain emergency situations, emergency personnel may need to locate a communication device and/or the person using it when the device and person are located indoors. In such a case, reliance on GPS may not be possible.

Time of flight (TOF) and time difference of arrival (TDOA) of a wireless signal transmitted by one device and received by another device are also commonly used methods to determine the location of a communication device, especially in a mobile ad-hoc multi-hopping network (MANET) or wireless mesh network. Both methods rely upon the measurement of time of arrival (TOA) of a wireless signal. Current methods for determining TOA use either pulse or impulse response procedures. The pulse method is not preferred because it requires very high energy and creates interference over a large frequency spectrum. The impulse response approach is negatively impacted by multi-path effects, especially when measurements are executed indoors where precision requirements are higher and reflections are more prominent. Multi-path effects make the correct estimation of the TOA and the computed TOF and TDOA extremely difficult when using frequencies in the Gigahertz (GHz) range (e.g., in the industrial, scientific, and medical (ISM) frequency band). As a result, locations estimated using existing TOF and TDOA methods can be affected by large errors and thus may be inaccurate.

Therefore, a need exists for a method and apparatus that facilitate the determination of distances between communication devices and optionally locations of the communication devices not only outdoors, but also indoors, and that overcome the limitations associated with GPS technology and the deficiencies associated with using pulse or impulse response TOA measurements.

### BRIEF DESCRIPTION OF THE FIGURES

The accompanying figures, in which like reference numerals refer to identical or functionally similar elements throughout the separate views and which together with the detailed description below are incorporated in and form part of the specification, serve to illustrate various embodiments and to explain various principles and advantages all in accordance with the present invention.

FIG. 1 is an electrical block diagram of an exemplary wireless communication network in accordance with some embodiments of the present invention.

FIG. 2 is an electrical block diagram of an exemplary wireless communication device in accordance with some embodiments of the present invention.

FIG. 3 is a graphical representation of pre-stored samples used for generating an exemplary ranging signal for transmission by a wireless communication device in accordance with some embodiments of the present invention.

FIG. 4 is a graphical representation of the ranging signal of FIG. 3 upon being received and sampled by a neighboring wireless communication device.

FIG. 5 is a logic flow diagram illustrating an exemplary method for determining a distance between wireless communication devices in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to determining distances between wireless communication devices using low frequency signals. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of determining distances between wireless communication devices using low frequency signals described herein. The non-processor circuits may include, but are not limited to, a radio receiver, a radio transmitter, signal drivers, clock circuits, power source circuits, and user input devices. As such, these functions may be interpreted as steps of a method to determine distances between wireless communication devices using low frequency signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention encompasses a method and apparatus for determining distances between wireless communications devices in a wireless communication network, such as a wireless mobile ad hoc multi-hopping network (MANET) or a wireless mesh network. A wireless device receives an incoming message signal from another wireless device in the network. The message signal includes a data or other message, which itself includes a time of arrival of a ranging signal previously transmitted by the wireless device. Responsive to receiving the message signal, the wireless device receives an incoming ranging signal from the other wireless device. The ranging signal is received in a frequency range that is substantially less than the frequency range in which the messaging signal was received. In other words, the ranging signal comprises a low frequency signal vis-à-vis the frequency of the message signal. For example, the message signal may be communicated in the industrial, scientific, and medical (ISM) frequency band (e.g., in the frequency range of about 900 MHz to about 6 GHz) and the ranging signal may be communicated in the low frequency band (e.g., in the range of about 30 KHz to about 300 KHz) or part of the high frequency band (e.g., up to about 3 MHz). In one embodiment, the frequency range in which the ranging signal is communicated is at least one and further at least three orders of magnitude less than the frequency range in which the message signal is communicated. Having received the message signal and the ranging signal, the wireless device then determines the distance between itself and the other wireless device based at least on receipt of the ranging signal and, based further on the contents of the message signal. In particular, the wireless device extracts the time of arrival of the device's previously transmitted ranging signal from the received message signal, determines the time of arrival of the received ranging signal, computes the signal propagation time (e.g., TOF and/or TDOA) between the wireless devices based on the two times of arrival, and then computes the distance between the devices based on the signal propagation time.

By determining the distance between two or more communication devices in this manner, the present invention enables wireless communication devices to be located accurately not only in areas where global positioning satellite (GPS) signals are available, but also in areas where GPS signals are not or may not be available, such as inside buildings, tunnels, mines, dense forests, or narrow city streets surrounded by tall buildings, without interfering with ongoing message (e.g., voice, data and/or video) communications. The present invention further provides a mechanism for synchronizing clocks within wireless devices to facilitate use of such protocols as time division multiple access (TDMA) protocols in wireless MANETs.

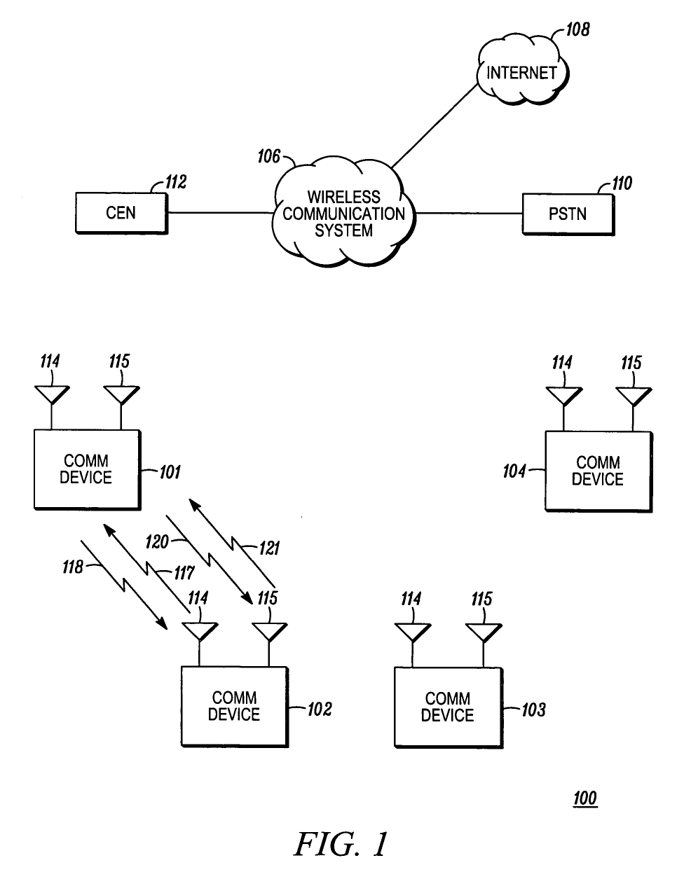

The present invention can be more readily understood with reference to FIGS. 1-5, in which like reference numerals designate like items. FIG. 1 is an electrical block diagram of an exemplary wireless communication network 100 in accordance with some embodiments of the present invention. It will be appreciated by those of ordinary skill in the art that the wireless network 100 can be any wireless communication network that includes two or more wireless communication devices 101-104 (e.g., four devices are shown in FIG. 1). It will be further appreciated by those of ordinary skill in the art that the wireless network 100 can be used to communicate any type or combination of information, including, without limitation, audio, video, and/or data. In the network 100 depicted in FIG. 1, the communication devices 101-104 can communicate either directly or indirectly (e.g., through one or more of the wireless devices 101-104 acting as a wireless router in accordance with conventional mesh networking techniques) with a wireless communication system 106, although such communication is not required. For example, the present invention is also applicable in MANETs in which the communication is solely between wireless devices 101-104 without interaction with and/or use of the wireless communication system 106.

It will be appreciated by those of ordinary skill in the art that the wireless communication system 106 can be any publicly accessible or any proprietary system, and can use any appropriate access and/or link protocol to communicate with the wireless communication devices 101-104, including, but not limited to, analog, digital, packet-based, time division multiple access (TDMA), direct sequence code division multiple access (CDMA), frequency hopping CDMA, wideband code division multiple access (WCDMA), frequency division multiple access (FDMA), spread spectrum or any other known or future developed access or link protocol or methodology. The wireless communication system 106 can further use any of a variety of networking protocols, such as, for example, User Datagram Protocol (UDP), Transmission Control Protocol/Internet Protocol (TCP/IP), AppleTalk™, Inter-Packet Exchange/Sequential Packet Exchange (IPX/SPX), Network Basic Input Output System (Net BIOS), or any proprietary or non-proprietary protocol, to communicate digital voice, data and/or video with the wireless devices 101-104 and/or other networks to which the wireless communication system 106 can be connected. For example, the wireless communication system 106 can be connected to one or more wide area networks, such as the Internet 108 and/or the public switched telephone network 110, or a private customer enterprise network (CEN) 112.

Each of the wireless communication devices 101-104 can be, for example, a cellular telephone, a mobile data terminal, a two-way radio, a personal digital assistant (PDA), a handheld computer, a laptop or notebook computer, a wireless email device, a two way messaging device, or any combination thereof, which has been modified or fabricated to include the functionality of the present invention. In the following description, the term “wireless communication device” refers to any of the devices mentioned above or any other device that operates in accordance with the present invention.

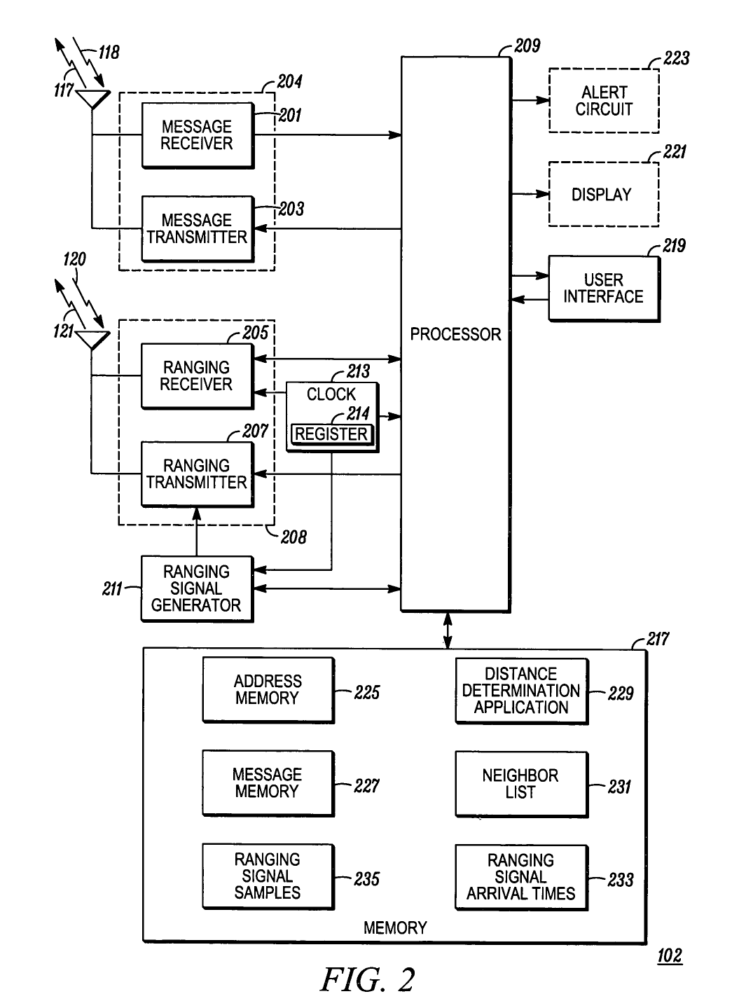

Each of the wireless communication devices 101-104 as illustrated includes at least two antennas 114, 115 and various other components as discussed in more detail below with respect to FIG. 2. The first antenna 114 is tuned to receive and transmit message and other signals 117, 118 in a first frequency band or sub-band and the second antenna 115 is tuned to receive and transmit ranging signals 117, 118 in a second frequency band or sub-band that is substantially lower in frequency than the band in which the message signals 117, 118 are communicated. Both the message signals 117, 118 and the ranging signals 120, 121 are discussed in more detail below with respect to FIGS. 2-5. For example, the message signals 117, 118 can be communicated in a frequency range that is at least an order of magnitude greater than the frequency range in which the ranging signals 120, 121 are communicated. In one embodiment, the message signals 117, 118 are communicated in the ISM band and, more particularly, in the 2.4 GHz or 4.9 GHz band. On the other hand, the ranging signals 120, 121 are communicated in a much lower frequency band, for example in the range of about 30 KHz to about 3 MHz.

FIG. 2 is an electrical block diagram of an exemplary wireless communication device 102 operating in the wireless communication network 100 in accordance with some embodiments of the present invention. One of ordinary skill in the art will recognize that all of the communication devices 101-104 of the wireless network 100 can be configured in a manner identical or at least substantially similar to the configuration of the wireless communication device 102 of FIG. 2.

The wireless communication device 102 includes the aforementioned antennas 114, 115, a message receiver 201, a message transmitter 203, a ranging receiver 205, a ranging transmitter 207, a processor 209, a ranging signal generator 211, a clock 213, a ranging signal analyzer 215, a memory 217, and a user interface 219. In one embodiment, the wireless communication device 102 further or optionally includes a display 223 and/or an alert circuit 221, as well as other conventional components (not shown).

As noted above, the first antenna 114 is configured to transmit and/or receive message signals 117, 118 to or from another wireless device (e.g., 101) and/or the wireless communication system 106. The message signals 117, 118 can be, for example, modulated audio, video, and/or data signals. The message signals 117, 118 are communicated over pre-established channels within the selected frequency band (e.g., the 2.4 GHz band) in accordance with known techniques.

The first antenna 114 is coupled to the message receiver 201, which employs conventional demodulation techniques for receiving incoming message signals 118 transmitted by another wireless device (e.g., 101) or by the communication system 106. The first antenna 114 is also coupled to the message transmitter 203, which employs conventional modulation and amplification techniques to convey outgoing message signals 117 to other communication devices 101, 103-104 and/or the wireless communication system 106. The message transmitter 203 is responsive to commands from the processor 209 instructing the transmitter 203 to send message signals 117 via the first antenna 114 to another communication device 101, 103-104 or the wireless communication system 106. The transmitted message signal 117 can, for example, include one or more data packets containing audio, textual, graphic, and/or video information.

In an alternative embodiment, the message receiver 201 and the message transmitter 203, or parts thereof, can be combined in accordance with known techniques to form a single modem or message transceiver 204. In yet another embodiment, the first antenna 114 can be replaced with two antennas such that one antenna (not shown) is coupled to the message receiver 201 and the other antenna (not shown) is coupled to the message transmitter 203.

The second antenna 115 is coupled to the ranging receiver 201, which employs conventional techniques to receive incoming, continuous wave or otherwise unmodulated ranging signals 120 transmitted by another wireless device (e.g., 101) and/or the wireless communication system 106. The ranging signal receiver 201 also includes an analog-to-digital converter as detailed below for use in accordance with some embodiments of the present invention. The second antenna 115 is also coupled to the ranging transmitter 203, which employs conventional amplification techniques to convey outgoing, continuous wave or otherwise unmodulated ranging signals 121 to other communication devices 101, 103-104 and/or the wireless communication system 106. The ranging transmitter 207 is responsive to commands from the processor 209 instructing the transmitter 207 to send ranging signals 121 via the second antenna 115 to another communication device 101, 103-104 or the wireless communication system 106. The transmitted ranging signal 121 can be an unmodulated signal, although, in an alternative embodiment, the ranging signal 121 can instead include one or more data packets containing audio, textual, graphic, and/or video information. In an alternative embodiment, the ranging receiver 205 and the ranging transmitter 207, or parts thereof, can be combined in accordance with known techniques to form a single ranging transceiver 208. In yet another embodiment, the second antenna 115 can be replaced with two antennas such that one antenna (not shown) is coupled to the ranging receiver 205 and the other antenna (not shown) is coupled to the ranging transmitter 207.

The processor 209 is coupled to the message receiver 201, the message transmitter 203, the ranging receiver 205 and the ranging transmitter 207. The processor 209 utilizes conventional signal-processing techniques for processing received message and ranging signals 118, 120, and for processing messages or ranging signals intended for transmission. The processor 209 can be a microprocessor, a microcontroller, a digital signal processor (DSP), a state machine, logic circuitry, or any other device or combination of devices that processes information based on operational or programming instructions stored in the memory 217. One of ordinary skill in the art will appreciate that the processor 209 can be implemented using multiple processors as may be required to handle the processing requirements of the present invention. One of ordinary skill in the art will further recognize that when the processor 209 has one or more of its functions performed by a state machine or logic circuitry, the memory containing the corresponding operational instructions can be embedded within the state machine or logic circuitry as opposed to being external to the processor 209.

In accordance with some embodiments of the present invention, the communication device 102 has one or more addresses or identities assigned thereto to enable the communication device 102 to identify and process message signals 118 intended for the communication device 102 and to provide an indicator of source for message signals 117 and ranging signals 121 transmitted by the communication device 102. Upon the wireless communication device 102 receiving a message signal 118, the processor 209 decodes an address in the demodulated data of the received message, compares the decoded address with one or more addresses stored in an address memory component 225 of the overall device memory 217, and, when the received address correlates substantially with an address stored in the address memory 225, proceeds to process the remaining portion of the received message.

To perform the necessary functions of the wireless communication device 102, the processor 209 is coupled to the memory 217, which can include random access memory (RAM), read-only memory (ROM), FLASH memory, electrically erasable programmable read-only memory (EEPROM), removable memory (e.g., a subscriber identification module (SIM) card), a hard drive, and/or various other forms of memory as are well known in the art. In one embodiment, the memory 217 includes several memory components, including, but not limited to, an address memory component 225, a message memory component 227, an application storage component 229, a neighbor list component 231, a ranging signal arrival time component 233, and a ranging signal sample component 235.

As noted above, the address memory component 225 (also referred to herein as “address memory”) stores the address or addresses that uniquely identifies the communication device 102. For example, the address memory 225 can include the device's international mobile subscriber identification (IMSI), telephone number, group identification, IP address, medium access control (MAC) address, and so forth. The message memory component 227 (also referred to herein as “message memory”) stores received and decoded messages for future display and/or other use by the communication device 102. For example, the message memory 227 can store text, graphic, and/or pictorial messages, voice messages, video messages, and any other messages received via message signals 118. Once the processor 209 has processed a received message signal 118, the processor 209 stores the decoded message in the message memory 227. It will be appreciated by one of ordinary skill in the art that the message memory 227 and/or the other memory components 225, 229-235 can each be a group of separately located memory areas in the overall or aggregate device memory 217.

The application storage component 229 (also referred to herein as “application memory”) stores one or more software applications for execution by the processor 209 during operation of the communication device 102. Pursuant to some embodiments of the present invention, the stored applications include, without limitation, one or more applications for controlling the operations of the various components 201-207, 211-223 of the communication device 102, and a distance determination application for determining distances between communication devices and, optionally, locations of communication devices in accordance with the methodology disclosed herein. The neighbor list component 231 (also referred to herein as “neighbor list”) stores a list of communication devices 101, 103-104 from which the communication device 102 has received ranging signals 120 to facilitate the determination of locations of such devices 101, 103-104 and itself as discussed in more detail below. The ranging signal arrival time component 233 stores the arrival times of received ranging signals 120 to facilitate the determination of distances between the communication device 102 and other communication devices 101, 103-104 in the network 100 as discussed in more detail below. The ranging signal arrival times 233 can be alternatively combined and correlated or associated with the neighbor list 231 in a single memory component (e.g., a table). The ranging signal sample component 235 stores ranging signal samples for use by the ranging signal generator 211 and incoming ranging signals 120 processed by the ranging signal analyzer 215, as discussed in more detail below. Certain signal samples stored in the ranging signal sample component 235 are used by the ranging transmitter 205 to produce a sinusoidal outgoing ranging signal 121 and certain other signal samples stored in the ranging signal sample component 235 are used by the processor 209 to determine the distance between the communication device 102 and another communication device (e.g., 101, 103 or 104), as also detailed below.

The user interface 219 can, for example, comprise a keypad, a keyboard, a touchpad, a touch screen, a scroll bar or button, a microphone, a speaker, a camera, and/or any other components that enable a user to interact with, operate, and/or supply information to the communication device 102. The user interface 219 allows the user of the communication device 102 to input information for inclusion in at least some of the outgoing message signals 117.

Upon receipt and processing of a message signal 118, and storage of a message extracted therefrom, the processor 209 generates a command signal to the alert circuit 223, when included, as a notification that the message has been received and stored. The alert circuit 223 can, for example, include a speaker (not shown) with associated speaker drive circuitry capable of playing voice, melodies, and other audible alerts, a vibrator (not shown) with associated vibrator drive circuitry capable of producing a physical vibration, one or more light emitting diodes (LEDs) (not shown) with associated LED drive circuitry capable of producing a visual alert, or a video imaging display capable of producing a visual video alert. It will be appreciated by one of ordinary skill in the art that other similar alerting means as well as any combination of the audible, vibratory, visual, and/or video alert outputs described above can be used to implement the optional alert circuit 223.

Responsive to receipt of a message and/or in response to input via the user interface 219, the processor 209 generates a command signal to the display 221, when included, to generate a visual indication or notification of the communication device activity. The optional display 55 can be any now known or future developed display technology, including, without limitation, a liquid crystal display, a dot matrix display, a plasma display, or an LED display.

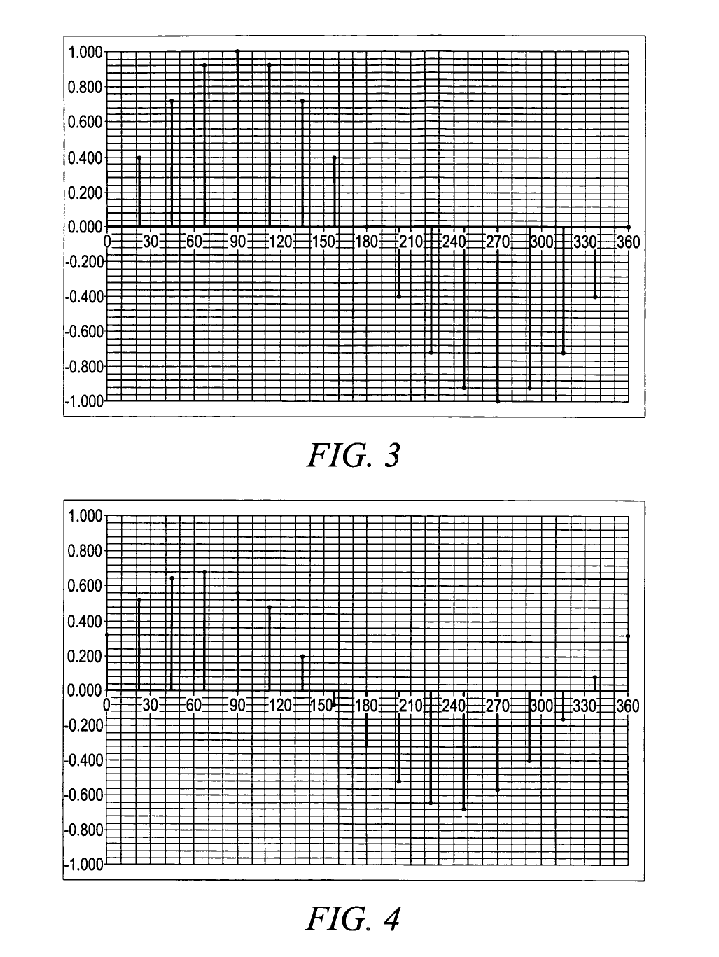

The ranging signal generator 211 in one embodiment comprises a digital-to-analog converter controlled by increments of the clock 213. The clock 213 includes an oscillator (not shown) and a register 214 for counting the oscillator ticks or increments, as is well understood in the art. The ranging signal generator 211 generates the ranging signal based on a table stored in the ranging signal sample memory 235 that describes in discrete form one cycle of an unmodulated sinusoidal signal (e.g., carrier only) in the predetermined frequency range of the outgoing ranging signal 121 (e.g., in the 30 kHz to 3 MHz range). Such a discrete or sampled form of an unmodulated sinusoidal signal is illustrated in exemplary form in FIG. 3. Once activated by the processor 209 and as otherwise discussed in detail below, the ranging signal generator 211 provides the outgoing ranging signal 121 to the ranging transmitter 207 for transmission typically several times in a row. The total duration of transmission of the outgoing ranging signals 121 can be, for example, from one to five milliseconds, although other transmission periods can be alternatively employed. Although depicted as being independent of the ranging transmitter 207, one of ordinary skill in the art will recognize that the ranging signal generator 211 can be embodied as part of and/or integrated into the ranging transmitter 207. Thus, all details related to the operation of the ranging signal generator 211 apply equally well to the operation of the ranging transmitter 207.

The ranging receiver 205 in one embodiment includes an analog-to-digital converter controlled by increments of the same clock 213 that controls the ranging signal generator 211. Alternatively, a separate clock (not shown) can be used to control the ranging receiver 205 provided that such additional clock is substantially synchronized to clock 213. The ranging receiver 205 samples the incoming ranging signals 120 transmitted by other communication devices 101, 103-104 and measures the received energy or strength of the received ranging signals 120. The collected samples (which are illustrated in exemplary form in FIG. 4) are stored in the ranging signal sample memory 235 from where they are processed by the processor 209 in order to determine the correct time of arrival (TOA) of the ranging signal 120. The TOA can then be used to determine the distance between the communication device 102 and the other device 101, 103-104, and, if so desired, the location(s) of the communication device 102 and/or the other communication devices 101, 103-104 in the network 100 with one or ore of a variety of known methods.

The clock 213 can also provide timing for the processor 209. The clock 213 in one embodiment includes a current time for use in the operation of the wireless communication device 102. The clock 213 can also provide a source of timing for feature enhancements of the communication device 102, such as active and inactive periods of operation or periods of alerting. Still further, the clock 213 can be synchronized with similar clocks in the other communication devices 101, 103-104 to facilitate time division multiple access (TDMA) signaling as described in more detail below.

Operation of the communication device 102 in accordance with the present invention can be more readily understood with further references to FIGS. 3-5. Under certain circumstances and utilizing common communication protocols, the wireless communication devices 101-104 can organize as a MANET and establish a radio frequency access sequence based on a predetermined criterion (e.g., the size of the devices' medium access control (MAC) addresses). When its turn in the transmission sequence comes, the particular communication device 102 generates a modulated outgoing message signal 118 and transmits (501) it to the other communication devices 101, 103-104. In addition, responsive to transmission of the message signal 117, the communication device 102 transmits (503) one or more unmodulated, outgoing ranging signals 121. The ranging signal generator 211 starts generating the outgoing ranging signal 121 when the clock register 214 has the value zero.

The clock 213 controlling the ranging signal generator 211 and ranging receiver 205 runs continuously and, at any instant in time, reflects a value indicative of the current relative time for the clock 213. In such a case, the oscillator ticks or increments are counted continuously by the register 214 until the register 214 overflows, thereby returning the register 214 and the clock 213 to a zero value from time to time. When the processor 209 orders transmission of the ranging signal(s) 121, the ranging signal generator 211 in one embodiment waits for the clock register 214 to return to zero (e.g., to overflow) and then commences transmission of the low frequency ranging signal 121 based on digital samples stored in the sample memory component 235. Alternatively, the transmission of the outgoing ranging signal 121 can be commenced when the clock register 214 reaches some other predetermined reference value (e.g., five ticks after returning to zero). The graph depicted in FIG. 3 illustrates exemplary values stored in the sample memory component 235 and submitted to the ranging signal generator 211 for generation of the outgoing ranging signal 121. As one of ordinary skill in the art will recognize, the exemplary values depicted in FIG. 3 are samples of a sinusoidal waveform starting at relative time zero and continuing for about a full cycle of 360 degrees. The sinusoidal waveform, S(t), can be represented by the following equation:
S(t)=sin(2πft)

The duration of the full cycle depends upon the frequency of the ranging signal 121. For example, at 30 KHz, the duration of one cycle is 33 microseconds; whereas, the duration of a full cycle is 330 nanoseconds (ns) at 3 MHz. One of ordinary skill in the art will recognize that the full cycle of the ranging signal 121 can be repeated any number of times. For example, a 330 ns cycle could be repeated 3000 times during one millisecond. From the sample values stored in the sample memory component 235, the ranging signal generator 211 creates a sinusoidal signal that is transmitted by the ranging transmitter 207, and received and sampled by the other communication devices 101, 103-104 located in proximity of the communication device 102.

The digital message transmitted in the high frequency outgoing message signal 117 can contain a list of neighbor devices 101, 103-104 from which incoming message and ranging signals 118, 120 have been previously received and the times of arrival (TOAs) of the respective ranging signals 120. The neighbor list 231 is stored in the memory 217 as discussed above. All the neighbor devices 101, 103-104 that receive the outgoing message signal 117 from the communication device 102 via their respective message signal receivers responsively turn on their low frequency ranging receivers and start sampling the outgoing ranging signal 121 transmitted by the communication device 102. The collected samples are then used for computing the TOA of the ranging signal 121 transmitted by the communication device 102. A similar process is performed for determining TOAs for the ranging signals transmitted from the other neighbor devices. Computation of TOA is more clearly described below with respect to message and ranging signals 118, 120 received at communication device 102.

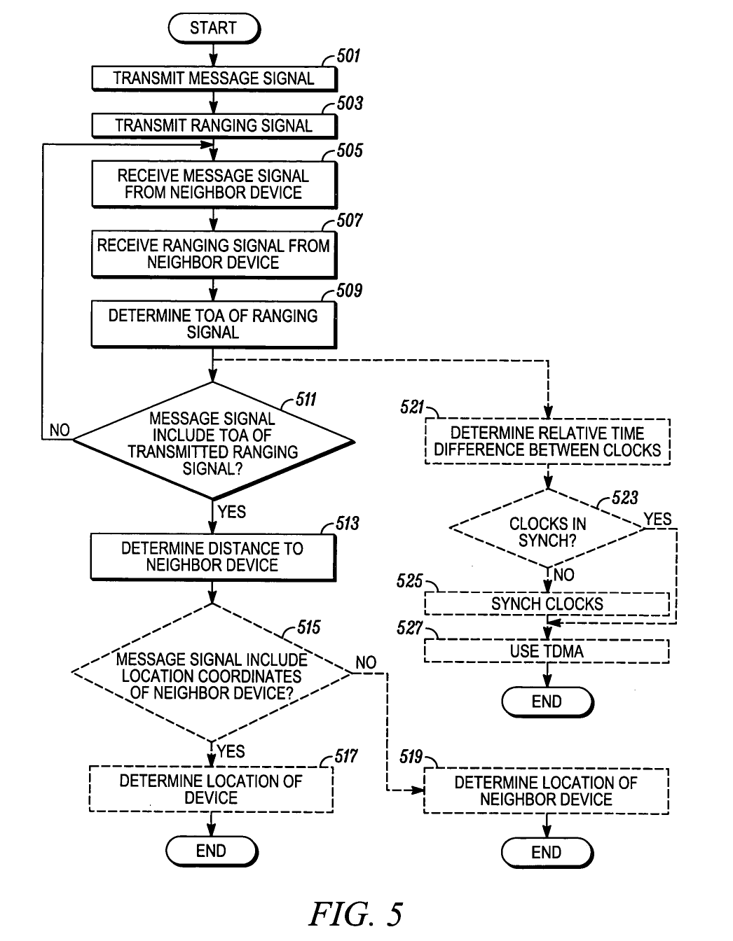

Depending on the communication device's position in the order of transmission amongst the wirelessly networked communication devices 101-104, the communication device 102 receives a message signal 118 from one of the communication devices (e.g., communication device 101) either before the communication device 102 transmits its message signal 117 and ranging signal 121 or some time thereafter (as is illustrated in the flow diagram of FIG. 5). However, even if the communication device 102 receives message and ranging signals 118, 120 prior to initially transmitting its own message and ranging signals 117, 121, the communication device 102 will eventually transmit message and ranging signals 117, 121, thereby effectively starting the logic flow depicted in FIG. 5. For purposes of the following discussion and the logic flow of FIG. 5, the reception of an incoming message signal 118 is assumed to occur at some time after the communication device 102 has transmitted the outgoing message and ranging signals 117, 121. As discussed above, if the communication device 102 had received incoming ranging signals 120 prior to transmitting its own message signal 117, the outgoing message signal 117 can include the identification (e.g., address) of the communication device 102, the TOAs of the previously received ranging signals 121, and an associated list of identifications of neighbor devices 101, 103-104 from which the ranging signals 121 were received.

Some time after transmission of the message and ranging signals 117, 121, the communication device receives (505) an incoming message signal 118 from another (e.g., neighbor) communication device (e.g., 101). The message signal 118 in one embodiment includes one or more messages that contain, among other things, the identification (e.g., address) of the sending device 101 and, if determined by the sending device 101, TOAs of ranging signals 121 transmitted by the communication device 102. Upon receiving the message signal 118, the communication device processor 209 decodes the address or other identifier of the communication device 101 that sent the message and stores the identifier in the neighbor list 231 (i.e., updates the neighbor list 231).

Additionally, responsive to receiving the message signal 118, the communication device processor 209 activates the ranging receiver 205 to receive (507) the incoming ranging signal 120 from the neighbor communication device 101. The ranging signal analyzer 215 samples the received ranging signal 120 at multiple sample times to produce a set of ranging signal samples and stores them in the appropriate memory component 235. The sample times are generated by the register output of the communication device's internal clock 213. Assuming that the ranging signal 120 received from the neighbor communication device 101 is substantially identical to the ranging signal 121 transmitted by the communication device 102, the values of the samples produced by the ranging signal analyzer 215 are an amplitude-reduced, phase-offset version of the ranging signal 121 transmitted by the communication device 102. An exemplary set of values generated by the ranging signal analyzer 215 and stored in the ranging signal sample memory component 235 responsive to receipt of the ranging signal 120 are graphically depicted in FIG. 4.

Ignoring the noise contained in the ranging signal 121, the equation for the received ranging signal samples, S(tᵢ), as depicted in FIG. 4 is:
S(tᵢ)=A sin(2πf(tᵢ+δ)).

The delay, δ, is the summation between the signal propagation time from the ranging signal transmitter of the neighbor communication device 101 to the ranging receiver 205 of the communication device 102, and the difference between the contents of the clock registers 214 (tick counters) at the two devices 101, 102. The signal value measured by the ranging signal analyzer 215 at each clock tick or increment may be mathematically referred to as Sᵢ. As a result, the equation for the received ranging signal samples becomes:
Sᵢ=A(sin(2πftᵢ)cos(2πfδ))+cos(2πftᵢ)sin(2πfδ)).

As one of ordinary skill in the art will recognize, the terms sin(2πftⁱ) and cos(2πftᵢ) are numbers that can be stored in a table in memory 217 because each tᵢ is a time value corresponding to a successive value of the clock register 214 (tick counter). If the clock register 214 increments every θseconds, tₒ=0, t₁=θ, t₂=2θ, . . . , tₙ=nθ. In the above equation of Sᵢ, the variables A, sin(2πfδ) and cos(2πfδ) are unknown quantities. However, one of ordinary skill in the art will recognize that the variable, A, is the channel equalization factor. As a result, the above equation for Sᵢ can be rewritten as:
Sᵢ=A(αᵢx+βᵢy), for i=0,1,2, . . . , n
where
   αᵢ=sin(2πfᵢθ), for i=0, 1, 2, . . . , n
   βᵢ=cos(2πfᵢθ), for i=0, 1, 2, . . . , n
   x=cos(2πfδ)
   y=sin(2πfδ).

In the foregoing equation, Sᵢ is the measured energy level of the received ranging signal 120 at every increment or tick of the clock register 214, αᵢ and βᵢ are known values and could be selected from the table, and A, x and y are unknown.

Supposing that the measured energy levels Sᵢ are affected by random errors, the set of n equations with three unknown variables can be solved by minimizing the expression:

$$E ( a , x , y ) = {\sum }_{i = 0}^{n} {( A ( {α}_{i} x + {β}_{i} y ) - {S}_{i} )}^{2} , \\ where$$

$${x}^{2} + {y}^{2} = 1.$$

Minimization of the above expression provides the values of A, x and y that gives the best estimation of the received ranging signal 120. The time of arrival (TOA) of the received ranging signal 120 in seconds is then computed from the following equation:

$$TOA = \frac{arctan ( \frac{y}{x} )}{2 π f} .$$

This equation for TOA can be stored in the application component 229 or some other portion of the device memory 217.

After receiving and sampling the incoming ranging signal 120, the processor 209 executes the distance determination application 229, which includes retrieving the stored ranging signal samples 235 for the received ranging signal 120, and determines (509) the TOA for the received ranging signal using the equation set forth above.

Once the TOA of the ranging signal 120 has been determined, the communication device 102 determines (511) whether the previously received message signal 118 included the TOA of the communication device's previously transmitted ranging signal 121. If no TOA is included in the message signal 118, the logic flow simply returns to block 505 to await receipt of a message signal 118 that includes the TOA of the previously transmitted message signal 117 as determined by a sending device 101. If, however, the received message signal 118 includes the TOA of the previously transmitted ranging signal 121, the communication device 102 determines (513) the distance (dᵢⱼ) between itself and the sending device 101 according to the following equation assuming that the ranging signal 120 was transmitted when the value of the other communication device's clock register 214 was zero:

$${d}_{i , j} = c ( \frac{{TOA}_{i , j} + {TOA}_{j , i}}{2} ) = c ( TOF ) ,$$

where c is the speed of light in free space, TOAᵢⱼ is the time of arrival of the ranging signal transmitted from device i to device j, and TOAⱼᵢ is the time of arrival of the ranging signal transmitted from device j to device i. Thus, based on the foregoing equation, the distance between device 102 and device 101 in meters as determined by device 102 is one-half the sum of the TOA of the incoming ranging signal 120 from device 101 as measured by device 102 and the TOA of the outgoing ranging signal 121 from device 102 as measured by device 101, all multiplied by the speed of light. One of ordinary skill in the art will recognize that dᵢⱼ=dⱼᵢ because both distances are computed from the same TOA measurements/data.

The foregoing process can be utilized by all the communication devices 101-104 in the network 100 to enable the communication devices 101-104 to determine respective distances between them. For example, communication device 102 can determine the distance between itself and another communication device 103 by transmitting a ranging signal 121 and subsequently receiving a message signal 118 from the other communication device 103, wherein the message signal 118 contains the TOA of the ranging signal 121 as computed by the other communication device 103 in the manner discussed above. Responsive to receiving the message signal 118, the communication device 102 receives a ranging signal 120 from the other communication device 103 and determines the TOA of the ranging signal 120. The communication device 102 then determines the distance between itself and the other communication device 103 by solving the distance equation provided above. In this manner, the communication device 102 determines the distance between itself and the other communication device 103 based at least on receipt and processing of the ranging signal 120 transmitted by the other device 103. Overall control of the operation of the communication device 102 as well as calculation of ranging signal TOA and determination of device-to-device distance is performed in one embodiment by the processor 209 executing the distance determination application 229 and other conventional operating applications (not shown).

Additionally or alternatively, the outgoing message signal 117 can include TOAs of ranging signals 120 received from several communications devices 101, 103-104 in the network 100, as well as an identification of the transmitting device (e.g., 102) and identifications of the various communication devices associated with the TOAs. Upon receiving such signal 117, the communications devices 101-104 in the network 100 can compute distances between themselves and the communication device 102 as well as relative or absolute location coordinates of all the listed devices using known techniques, such as those described in U.S. Pat. No. 6,728,545 entitled “System and Method for Computing the Location of a Mobile Terminal in a Wireless Communications Network”; “Signal Processing Techniques in Network Aided Positioning,” Guolin Sun et al., IEEE Signal Processing Magazine, July 2005, pp. 12-22; “Network-Based Wireless Location,” Ali H. Sayed et al., IEEE Signal Processing Magazine, July 2005, pp. 24-39; or “Mobile Positioning Using Wireless Networks,” Fredrik Gustafsson et al., IEEE Signal Processing Magazine, July 2005, pp. 41-52, the entire contents of each of which is fully incorporated herein by this reference. The equations set forth above and the determinations of location coordinates using the aforementioned publications apply only to the use of TOF in the distance and location computations. If TDOA is used as the basis for computing distances and locations, one of ordinary skill in the art will recognize that the TOA information broadcast in message signals 117, 118 transmitted throughout the network 100 can be used to compute the differences between the propagation time of a ranging signal 121 between the communication device 102 and two neighbor devices 101, 103 using the following equation, where TDOA between device i and device j is determined by device k:

$${TDOA}_{i , j} = {TOA}_{i , k} - ( {TOA}_{j , k} + \frac{{TOA}_{i , j} - {TOA}_{j , i}}{2} )$$

Derivation of the foregoing equation of TDOA_{i,j} may be more readily understood from the following example. It is assumed for purposes of this example that the network 100 only has three communication devices 101-103. Communication device 101 (device A) receives ranging signals from communication device 102 (device B) and communication device 103 (device C) and measures their respective times of arrival (TOA_{BA} and TOA_{CA}). Communication device 101 broadcasts the last measured TOA values every time it transmits a message signal 117. In a similar manner, communication devices 102 and 103 measure and transmit the values of the times of arrival for ranging signals received by them (e.g., TOA_{AB}, TOA_{CB}, TOA_{AC} and TOA_{BC}).

If the difference between the clock 213 running in communication device 101 and the clock 213 running in communication device 102 is denoted D_{AB} and the difference between the clock 213 running in communication device 101 and the clock 213 running in communication device 103 is denoted D_{AC}, then, due to the fact that clock shifts are differences between the register clock values in the communication devices 101-103, one of ordinary skill in the art can set forth the relationships between the clock differences by at least the following equations:
D_{AB}=−D_{BA},
D_{AC}=−D_{CA},
D_{BC}=−D_{CB},
D_{AB}=D_{AC}+D_{CB}.

The following table (Table 1) illustrates the values of the clock registers 214 when different events happen in the network 100, assuming that the propagation time of the ranging signal between respective pairs of devices 101-103 is denoted as p_{AB}, p_{AC} and p_{BC}. Evidently, p_{AB}=p_{AC} and so on.

TABLE 1

| Event | A clock | B clock | C clock |
|---|---|---|---|
| A transmits | 0 | −D_{AB} | −D_{AC} |
| B receives signal from A | p_{AB} | TOA_{BA} = p_{AB} − D_{AB} | |
| C receives signal from A | p_{AC} | | TOA_{CA} = p_{AC} − D_{AC} |
| B transmits | D_{AB} | 0 | −D_{BC} |
| A receives signal from B | TOA_{AB} = D_{AB} + p_{AB} | p_{AB} | |
| C receives signal from B | | p_{BC} | TOA_{CB} = p_{BC} − D_{BC} |
| C transmits | D_{AC} | D_{BC} | 0 |
| A received signal from C | TOA_{AC} = D_{AC} + p_{AC} | | p_{AC} |
| B receives signal from C | | TOA_{BC} = D_{BC} + p_{BC} | p_{BC} |

The italicized information in the table denotes the measured TOAs that are broadcast by the communication device identified as having received the ranging signal. As a result, such TOAs are received and therefore known by every device 101-103 in the network 100. Each device 101-103 can then compute the propagation time of the signal between communication device 101 and communication device 102 from the following equation:
p_{AB}=p_{BA}=½(TOA_{BA}+TOA_{AB}).

The clock correction between communication device 101 and communication device 102 (D_{BA}) is then determined as follows:
D_{AB}=D_{BA}=½(TOA_{AB}−TOA_{BA}).

Communication device 103 can compute TDOA_{AB} (the difference of time of arrival between a signal from communication device 101 and a signal from communication device 102) in the following manner:

$$\begin{matrix}{TDOA}_{AB} = {TOA}_{AC} - ( {TOA}_{BC} + {D}_{AB} ) \\ = {D}_{AC} + {p}_{AC} - ( {D}_{BC} + {p}_{BC} + {D}_{AB} ) \\ = {p}_{AC} - {p}_{BC} + {D}_{AC} - ( {D}_{BC} + {D}_{AB} ) \\ = {p}_{AC} - {p}_{BC}\end{matrix}$$

$$because$$

$${D}_{A C} = {D}_{AB} + {D}_{BC} .$$

Since communication device 102 is not synchronized with communication device 101, the reception time of communication device 102 is corrected by D_{AB}, the clock shift of communication device 102 with reference to the clock time of communication device 101. If communication device 101 and communication device 102 are synchronized, the value of D_{AB} is zero. Based on the foregoing equation, one of ordinary skill will recognize that TDOA_{AB} is equivalent to the difference in propagation times as measured by the two communication devices 101, 102. Thus, the TDOA_{AB} can be computed solely from measured and broadcast TOAs as:
TDOA_{AB}=TOA_{AC}−(TOA_{BC}+D_{AB})=TOA_{AC}−(TOA_{BC}+½(TOA_{AB}−TOA_{BA})).
In yet another embodiment, one of the wireless devices (e.g., 101) or the wireless communication system 106 is designed and/or designated for collecting the TOAs from all the other communication devices 102-104 (or all the wireless devices 101-104 when the wireless system 106 is designated as the collector) and computing the location coordinates for all the wireless devices 101-104 of the network 100. Based on such information, the collector device can compute time of flight (TOF) between each pair of communication devices and then compute the locations of the devices 101-104 using the techniques described in co-pending U.S. patent application Ser. No. 11/197,950, entitled “Bandwidth Efficient System and Method for Ranging Nodes in a Wireless Communication Network” filed Aug. 5, 2005, which is owned by the assignee of the present application and is fully incorporated herein by this reference. In such an embodiment, all the wireless communication devices 101-104 can be mobile. If all the communication devices 101-104 are programmed to transmit ranging signals 121 when their respective clock registers 214 are at zero or some other predefined value and the TOA of each received ranging signal 120 is broadcast to all devices 101-104 in a message signal 117, then any device 101-104 in the network 100 can determine the TOF between any two respective neighbor devices from the distance (dᵢⱼ) equation set forth above and use the TOF in the methodology set forth in U.S. Pat. No. 6,728,545, which was incorporated by reference hereinabove, or co-pending U.S. patent application Ser. No. 11/197,951, entitled “Autonomous Reference System and Method for Monitoring the Location and Movement of Objects”, which is owned by the assignee of the present application and is fully incorporated herein by this reference, to compute the location coordinates of the communication devices 101-104 if at least some of the communication devices are at fixed locations. If all of the communication devices are mobile or have unknown coordinates, then the TOF computations can be used to determine communication device locations based on the location determination technique disclosed in co-pending U.S. patent application Ser. No. 11/197,950, which was incorporated by reference hereinabove.

In another embodiment, some of the wireless communication devices (e.g., 101) are fixed, while others (e.g., 102-104) are mobile. In this case, the fixed devices 101 have known location coordinates and store them in memory 217. The fixed devices 101 broadcast their coordinates in message signals either together with TOAs measured for ranging signals transmitted by the mobile devices 102-104 or on demand. The mobile devices 102-104 measure and collect TOA values from all fixed neighbor devices 101 and compute their own location coordinates using conventional methods, such as the method disclosed in U.S. Pat. No. 6,728,545, which was incorporated by reference hereinabove.

In yet another optional embodiment, the message signal 118 received from the neighbor device 101 can further include location coordinates for itself and/or other wireless devices from which the neighbor device 101 has received ranging signals, location coordinates, TOAs, or other location-related information. As a result, the communication device 102 can determine (515) whether the received message signal 118 includes location coordinates of the neighbor device 101. If the received message signal 118 includes estimated or actual location coordinates of the neighbor device 101, the communication device 102 determines (517) the estimated location coordinates of itself based at least upon the location coordinates of the neighbor device 101 and the computed distance between the communication device 102 and the neighbor device 101. In one embodiment, the communication device 102 utilizes the location coordinates of the neighbor device 101 as well as location coordinates of at least two other neighbor devices 103, 104 (which coordinates may have been independently determined by the communication device 102, supplied by the neighbor device 101 or supplied individually by the other neighbor devices 103, 104) to compute its own location using conventional triangulation techniques. Alternatively, the communication device 102 can compute its location using the techniques disclosed in U.S. Pat. No. 6,728,545 or any other known method.

If the received message signal 118 does not include location coordinates of the neighbor device 101, the communication device 102 can determine (519) the estimated location of the neighbor device 101 using the methodology disclosed in U.S. patent application Ser. No. 11/197,951.

In yet another embodiment, the communication device 102 can determine (521) the relative time difference between the clock 213 in each device 101, 102 from the broadcasted TOA values. If all clocks 213 in all the communication devices 101-104 run continuously and include identically sized registers 214, the difference in value between the clock register 214 of the communication device 102 and the clock register of the neighbor device 101 can be computed by the processor 209 using the following equation:

$${D}_{ij} = \frac{{TOA}_{ij} - {TOA}_{ji}}{2}$$

Dᵢⱼ is the relative clock shift and can be used for synchronizing the clocks 213 of the two devices 101, 102. Similarly, the respective relative clock shifts between each pair of wireless communication devices can be used to effectively synchronize the clocks 213, 237 of all the wireless communication devices 101-104 in the network 100.

Based on the determination of the relative time difference (Dᵢⱼ), the communication device 102 determines (523) whether its clock 213 is in synchronization with the clock of the neighbor device 101 from which the ranging signal 120 was received. If the two clocks are in synchronization (i.e., the absolute value of Dᵢⱼ is smaller than the precision required by each particular application (e.g., less than 20 nanoseconds in a typical TDMA application), the transmissions of the message signals 117 can be programmed to start when the value of the clock register 214 is zero or some other predetermined value, and the communication devices 101, 102 can use (527) TDMA to exchange messages. If the two clocks are not in synchronization (i.e., the absolute value of Dᵢⱼ is larger than the precision required for the particular application), the communication device 102 can adjust the value of the clock register 214 and clock 237 based upon the computed time difference to synchronize (525) its clock 213 with the clock of the neighbor device 101 and thereby facilitate use of TDMA signaling between the two devices 101, 102 (and optionally between all devices 101-104 in the network 100). Use of TDMA allows the network 100 to more efficiently utilize available frequency spectrum and thereby accommodate a relatively large number of communication and ranging devices.

The present invention encompasses a method and apparatus for determining distances between wireless communications devices in a wireless communication network, such as a MANET or a wireless mesh network. With this invention, communication devices and their users can be accurately located in environments that are not conducive to use of GPS technology, such as inside buildings, mines, tunnels, or dense forests. For example, the present invention can be used in radios carried by firefighters or other emergency personnel in order to allow such radios to form MANETs and locate one another during in-building or out-of-building emergencies. Since the ranging signals disclosed above are repeatedly transmitted by each communication device of the network, the TOAs of the ranging signals are also repeatedly and redundantly measured so as to minimize errors and provide very high precision TOA (e.g., to within a few nanoseconds) and distance measurements. Further, the present invention does not require high precision network synchronization and accordingly can be implemented using low quality clocks. Still further, the present invention provides a mechanism for synchronizing the devices' individual clocks if so desired to facilitate use of TDMA signaling to increase the capacity of the network.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for determining distances between wireless communication devices, the method comprising:
receiving, by a first wireless communication device, an incoming message signal in a first frequency range from a second wireless communication device, the incoming message signal including at least one message;
responsive to receiving the incoming message signal, receiving, by the first wireless communication device, at least one incoming ranging signal in a second frequency range from the second wireless communication device, the second frequency range being substantially lower in frequency than the first frequency range; and
determining, by the first wireless communication device, a distance between the first wireless communication device and the second wireless communication device based at least upon receipt of the at least one incoming ranging signal.

2. The method of claim 1, wherein the first frequency range is at least an order of magnitude greater in frequency than the second frequency range.

3. The method of claim 2, wherein the first frequency range includes frequencies that are greater than approximately one hundred Megahertz and wherein the second frequency range includes frequencies that are less than approximately three Megahertz.

4. The method of claim 3, wherein the first frequency range is in the range of about 2.4 Gigahertz to about 4.9 Gigahertz and wherein the second frequency range is in the range of about 30 kilohertz to about 3 Megahertz.

5. The method of claim 1, wherein the step of receiving the at least one incoming ranging signal comprises sampling the at least one incoming ranging signal at a plurality of sample times, the plurality of sample times being generated by an internal clock of the first wireless communication device.

6. The method of claim 1, further comprising:
receiving, by the first wireless communication device, at least a second incoming message signal in the first frequency range from at least a third wireless communication device, the at least a second incoming message signal including at least a second message;
responsive to receiving the at least a second incoming message signal, receiving, by the first wireless communication device, at least a second incoming ranging signal in the second frequency range from the at least a third wireless communication device; and
determining, by the first wireless communication device, a distance between the first wireless communication device and the at least a third wireless communication device based at least upon receipt of the at least a second incoming ranging signal.

7. The method of claim 1, wherein the incoming message signal is a modulated signal, wherein the at least one incoming ranging signal is at least one unmodulated signal, and wherein the message includes at least one data packet.

8. The method of claim 1, wherein the step of determining a distance between the first wireless communication device and the second wireless communication device further comprises:
determining at least one time of arrival of the at least one incoming ranging signal.

9. The method of claim 8, further comprising:
transmitting, by the first wireless communication device, at least one outgoing ranging signal in the second frequency range to at least the second wireless communication device prior to receiving the at least one incoming ranging signal from the second wireless communication device;
wherein the message received from the second wireless communication device at least includes at least one time of arrival of the at least one outgoing ranging signal as determined by the second wireless communication device, and wherein the step of determining a distance between the first wireless communication device and the second wireless communication device further comprises:
determining the distance between the first wireless communication device and the second wireless communication device based at least upon the at least one time of arrival of the at least one incoming ranging signal and the at least one time of arrival of the at least one outgoing ranging signal.

10. The method of claim 9, further comprising:
transmitting, by the first wireless communication device, an outgoing message signal in the first frequency range to at least the second wireless communication device, the outgoing message signal including an identification of the first wireless communication device, identifications of neighboring wireless communication devices and times of arrival of incoming ranging signals received from the neighboring wireless communication devices,
wherein transmission of the at least one outgoing ranging signal is responsive to transmission of the outgoing message signal.

11. The method of claim 9, wherein the first wireless communication device includes a first clock based upon which transmissions from the first wireless communication device are commenced and wherein the second wireless communication device includes a second clock based upon which transmissions from the second wireless communication device are commenced, the method further comprising:
determining a relative time difference between the first clock and the second clock based upon the at least one time of arrival of the at least one incoming ranging signal and the at least one time of arrival of the at least one outgoing ranging signal; and
synchronizing the first clock and the second clock based upon the relative time difference to facilitate time division multiple access signaling between the first wireless communication device and at least the second wireless communication device.

12. The method of claim 9, wherein the first wireless communication device includes a clock based upon which at least transmission commences, wherein the clock includes a register operable to establish a current time for the clock, and wherein the step of transmitting at least one outgoing ranging signal in the second frequency range comprises commencing transmission of the at least one outgoing ranging signal when a value stored in the register is a predetermined reference value.

13. The method of claim 12, wherein the predetermined reference value is zero.

14. The method of claim 1, further comprising:
transmitting, by the first wireless communication device, an outgoing message signal in the first frequency range to at least the second wireless communication device, the outgoing message signal including an identification of the first wireless communication device, identifications of neighboring wireless communication devices and times of arrival of incoming ranging signals received from the neighboring wireless communication devices.

15. The method of claim 1, further comprising:
determining, by the first wireless communication device, location coordinates of the first wireless communication device based at least upon the distance between the first wireless communication device and the second wireless communication device.

16. The method of claim 15, wherein the at least one message includes location coordinates of the second wireless communication device and wherein the step of determining location coordinates of the first wireless communication device comprises:
determining location coordinates of the first wireless communication device based at least upon the location coordinates of the second wireless communication device and the distance between the first wireless communication device and the second wireless communication device.

17. A method for a first wireless communication device to determine a distance between the first wireless communication device and a second wireless communication device, the method comprising:
transmitting at least one outgoing ranging signal in a first frequency range to at least the second wireless communication device;
receiving, from the second wireless communication device, an incoming message signal in a second frequency range, the incoming message signal including an identification of the second wireless communication device and at least one time of arrival of the at least one outgoing ranging signal as determined by the second wireless communication device, the second frequency range being at least an order of magnitude greater in frequency than the first frequency range;
responsive to receiving the incoming message signal, receiving, from the second wireless communication device, at least one incoming ranging signal in the first frequency range;
determining at least one time of arrival of the at least one incoming ranging signal; and
determining a distance between the first wireless communication device and the second wireless communication device based at least upon the at least one time of arrival of the at least one incoming ranging signal and the at least one time of arrival of the at least one outgoing ranging signal.

18. A wireless communication device comprising:
a first receiver operable to receive an incoming message signal in a first frequency range from a second wireless communication device, the incoming message signal including at least one message;
a second receiver operable to receive at least one incoming ranging signal in a second frequency range from the second wireless communication device, the second frequency range being substantially lower than the first frequency range;
a processor operably coupled to the first receiver and the second receiver; and
a memory device operably coupled to the processor, the memory device storing a software program that, when executed by the processor, causes the processor to:
control operation of the second receiver such that the second receiver receives the incoming ranging signal responsive to the first receiver receiving the incoming message signal; and
determine a distance between the wireless communication device and the second wireless communication device based at least upon receipt of the at least one incoming ranging signal.

19. The wireless communication device of claim 18, wherein the software program stored in the memory, when executed by the processor, further causes the processor to determine at least one time of arrival of the at least one incoming ranging signal and determine the distance between the wireless communication device and the second wireless communication device based at least upon the at least one time of arrival.

20. The wireless communication device of claim 19, further comprising:
a transmitter, operably coupled to the processor, operable to transmit at least one outgoing ranging signal in the second frequency range to at least the second wireless communication device;
wherein the message received from the second wireless communication device at least includes at least one time of arrival of the at least one outgoing ranging signal as determined by the second wireless communication device, and wherein the software program stored in the memory, when executed by the processor, further causes the processor to determine the distance between the wireless communication device and the second wireless communication device based at least upon the at least one time of arrival of the at least one incoming ranging signal and the at least one time of arrival of the at least one outgoing ranging signal.

21. The wireless communication device of claim 19, further comprising:
a clock operably coupled to at least the second receiver and the transmitter, the clock including a register operable to establish a current time for the clock, the clock being operable to control times at which the second receiver samples the at least one incoming ranging signal and times at which the at least one outgoing ranging signal is generated for transmission;
wherein the transmitter is further operable to initiate transmission of the at least one outgoing ranging signal when a value stored in the register is a predetermined reference value.

22. The wireless communication device of claim 21, wherein the second wireless communication device includes a second clock based upon which transmissions from the second wireless communication device are commenced, and wherein the software program stored in the memory, when executed by the processor, further causes the processor to:
determine a relative time difference between the clock and the second clock based upon the at least one time of arrival of the at least one incoming ranging signal and the at least one time of arrival of the at least one outgoing ranging signal; and
synchronize the clock to the second clock based upon the relative time difference to facilitate time division multiple access signaling between the wireless communication device and at least the second wireless communication device.
